(19) United States
(12) Patent Application Publication
(10) Pub. No.: US 2026/0251960 A1
(43) Pub. Date: Aug. 27, 2026

(54) IMAGE PICKUP APPARATUS

(71) Applicant: CANON KABUSHIKI KAISHA, Tokyo (JP)

(72) Inventor: SHO NAGATSU, Kanagawa (JP)

(21) Appl. No.: 19/651,226

(22) Filed: Apr. 17, 2026

Related U.S. Application Data
(63) Continuation of application No. PCT/JP2024/030853, filed on Aug. 29, 2024.

(30) Foreign Application Priority Data
Nov. 28, 2023 (JP) 2023-200291

(51) Int. Cl. G03B 17/14; G02B 7/00; G03B 11/00; H04N 23/55; H04N 23/75

(52) U.S. Cl. CPC G03B 17/14; G02B 7/006; G03B 11/00; H04N 23/55; H04N 23/75

(57) ABSTRACT

An image pickup apparatus includes an optical filter rotatable between a first position that covers an opening in the mount portion and a second position that does not overlap the opening, and a connection member that electrically connects the optical filter and a substrate. The connection member includes a connector connected to the optical filter, a first portion extending from the connector, a bent portion connected to the first portion, and a second portion connected to the bent portion. When the optical filter is located at the first position, the first portion extends toward a rotation retraction region of the optical filter, and the optical filter and the second portion do not overlap each other when viewed from an object side. When the optical filter is located at the second position, the optical filter and the second portion overlap each other when viewed from the object side.

### CROSS-REFERENCE TO RELATED APPLICATIONS

This application is a Continuation of International Patent Application No. PCT/JP2024/030853, filed on August 29, 2024, which claims the benefit of Japanese Patent Application No. 2023-200291, filed on November 28, 2023, both of which are hereby incorporated by reference herein in their entirety.

### BACKGROUND

### FIELD OF THE TECHNOLOGY

The present disclosure relates to an image pickup apparatus having an optical filter.

### DESCRIPTION OF THE RELATED ART

In one conventional structure for an image pickup apparatus having an electronic ND filter that is rotationally driven during insertion and removal, a flexible printed circuit board (FPC) connected to the electronic ND filter has a portion extending parallel to an imaging optical axis in order to accommodate rotational driving of the electronic ND filter. However, since internal components are densely arranged in an optical path from a mount to an imaging unit in a compact image pickup apparatus such as a mirrorless camera, the FPC may interfere with the internal components in a case where the above structure is used. In a case where applications of the electro-optical filter are diversified, the number of control signals increases, but the above structure causes the size of the image pickup apparatus to increase.

Japanese Patent Application Laid-Open No. 2018-077453 discloses an image pickup apparatus that accommodates rotational driving of a lens unit by providing an arc-shaped portion in an FPC connected to the lens unit.

However, in the image pickup apparatus disclosed in Japanese Patent Application Laid-Open No. 2018-077453, the FPC does not overlap the lens unit during the rotation of the lens unit. Therefore, the size of the image pickup apparatus cannot be reduced.

### SUMMARY

An image pickup apparatus according to one aspect of the present disclosure to which a lens apparatus is detachably attachable via a mount portion may include an optical filter rotatable between a first position that covers an opening provided inside the mount portion and a second position that does not overlap the opening, and a connection member that electrically connects the optical filter and a substrate. The connection member may include a connector connected to the optical filter, a first portion extending from the connector, a bent portion connected to the first portion, and a second portion connected to the bent portion. In a case where the optical filter is located at the first position, the first portion may extend toward a rotation retraction region of the optical filter, and the optical filter and the second portion do not overlap each other when viewed from an object side. In a case where the optical filter is located at the second position, the optical filter and the second portion may overlap each other when viewed from the object side.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external perspective views of an image pickup apparatus according to an embodiment of the present disclosure.

FIG. 2 is a block diagram illustrating an electrical configuration of the image pickup apparatus.

FIG. 3 is an exploded perspective view of the image pickup apparatus.

FIGS. 4A and 4B are configuration diagrams during driving of an electro-optical filter.

FIGS. 5A, 5B, and 5C are explanatory diagrams illustrating operations of the electro-optical filter and an electrical connection member during rotational driving.

FIGS. 6A, 6B, and 6C are detailed explanatory diagrams of the electro-optical filter and the electrical connection member.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted.

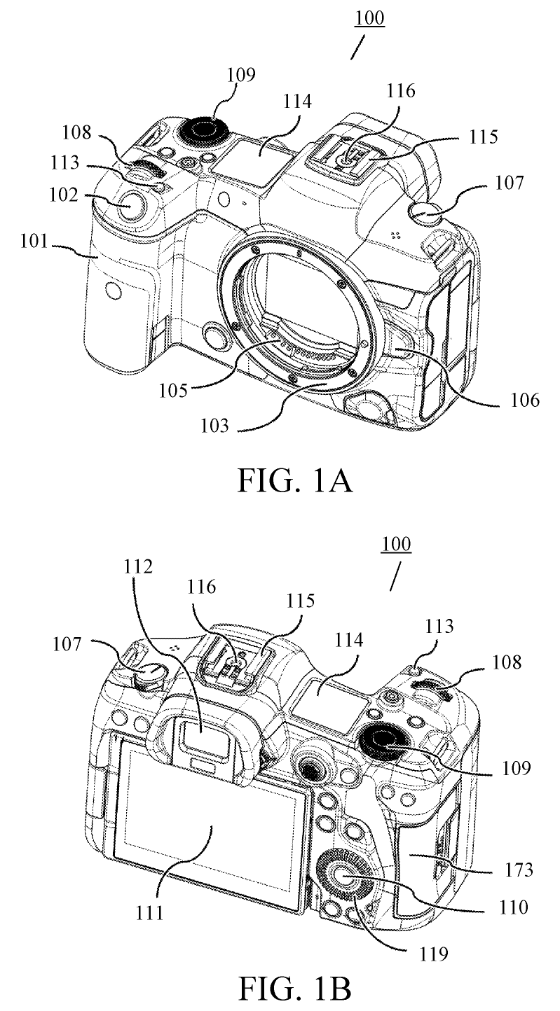

FIGS. 1A and 1B are external perspective views of an image pickup apparatus 100 according to an embodiment of the present invention. FIG. 1A is an external perspective view of the image pickup apparatus 100 when viewed from a front side, and FIG. 1B is an external perspective view of the image pickup apparatus 100 when viewed from a rear side.

A grip portion 101 is provided to allow a photographer to stably hold the image pickup apparatus 100. A shutter button 102, which is a switch for starting imaging, is provided on an upper portion of the grip portion 101. A lens mount portion (mount portion) 103 is provided on a front surface of the image pickup apparatus 100. The image pickup apparatus 100 is configured such that an imaging lens unit (lens apparatus) 104 (not illustrated) is detachably mounted via the lens mount portion 103. Mount contacts 105 electrically connect the image pickup apparatus 100 and the imaging lens unit 104, and perform power supply to the imaging lens unit 104 and communication on lens control and lens data via electrical signals. A lens unlock button 106 is used in a case where the imaging lens unit 104 is to be replaced. In a case where the lens unlock button 106 is pressed, the image pickup apparatus 100 and the imaging lens unit 104 are disengaged, and the imaging lens unit 104 may be detached.

A power switch 107 is used to power on and off the image pickup apparatus 100. A main electronic dial 108 and a sub electronic dial 119 are rotational operation members rotatable clockwise and counterclockwise, and a variety of setting values such as an aperture value (F-number) and a shutter speed may be changed by rotational operation. A mode switching dial 109 is an operation member for switching an imaging mode (shooting mode). By operating the mode switching dial 109, the mode may be switched between a variety of modes such as a shutter-speed-priority imaging mode, an aperture-priority imaging mode, and a moving-image imaging mode. A setting button 110 is a push button mainly used for determining a selected item. A liquid crystal monitor 111 displays a variety of setting screens of the image pickup apparatus 100, captured images, and live-view images.

An electronic viewfinder (EVF) 112 is an eyepiece-viewable finder that displays a variety of setting screens of the image pickup apparatus 100, captured images, and live-view images. A multi-function button 113 is a push button to which a user may arbitrarily assign switching of a variety of settings relating to imaging. A display panel 114 displays a variety of setting states of the image pickup apparatus 100 such as an imaging mode and an ISO sensitivity (ISO speed). The display panel 114 may perform display even in a case where the image pickup apparatus 100 is powered off. An accessory shoe 115 includes accessory contacts 116 and allows a variety of accessories such as an external strobe or a microphone to be attached. A media slot cover 173 is openable and closable, and in the open state, an external recording medium 148 (not illustrated) such as an SD card may be inserted into or removed from a media slot 172 (not illustrated) inside.

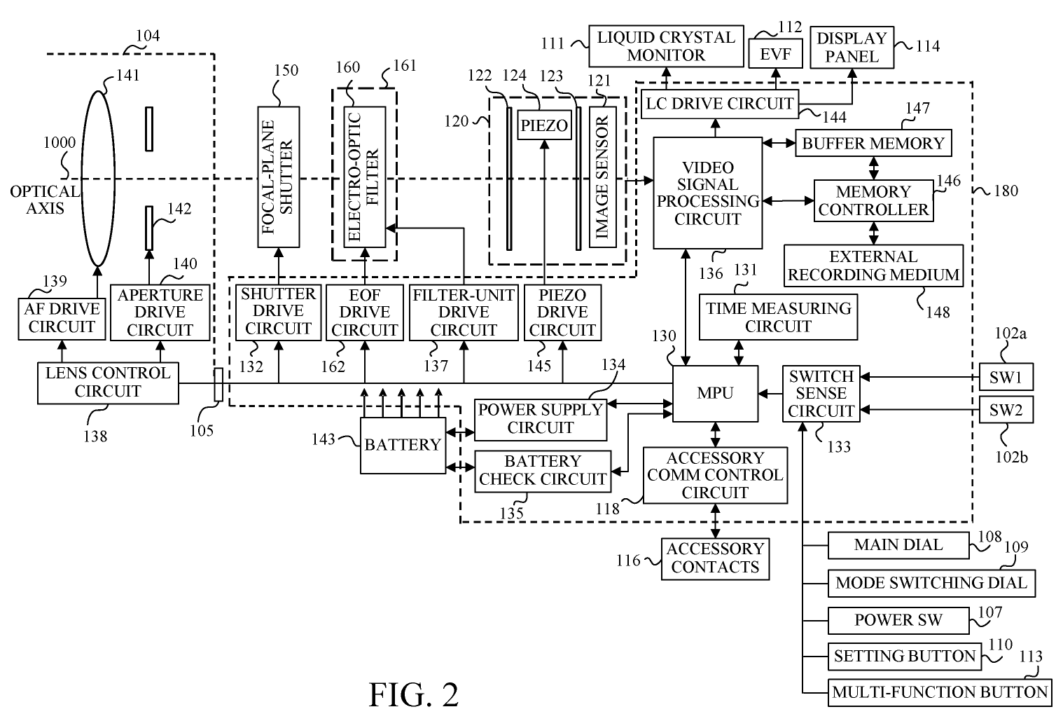

FIG. 2 illustrates a block diagram illustrating an electrical configuration of the image pickup apparatus 100. An MPU (control unit) 130 is a small central processing unit (MPU) that controls operation of the image pickup apparatus 100, processes input information, and provides instructions and control to respective elements. A time measurement circuit 131, a shutter driving circuit 132, a switch sense circuit 133, a power supply circuit 134, and a battery check circuit 135 are connected to the MPU 130. A video signal processing circuit 136, a filter-unit drive circuit 137, a piezoelectric element (PIEZO) drive circuit 145, and an electro-optic filter drive circuit 162 are connected to the MPU 130. The MPU 130 includes an EEPROM and may store time information obtained by the time measuring circuit 131 and various setting information.

The MPU 130 communicates with a lens control circuit 138 built in the imaging lens unit 104 via the mount contacts 105. Thereby, the MPU 130 can control operations of a focus lens 141 and an electromagnetically driven diaphragm 142 via an autofocus (AF) drive circuit 139 and an aperture drive circuit 140. Although only the focus lens 141 is schematically illustrated in FIG. 2, the imaging lens unit 104 actually includes a plurality of lens units.

The AF drive circuit 139 is connected to, for example, a stepping motor (not illustrated) and drives the focus lens 141. The MPU 130 calculates a focus-lens driving amount based on a defocus amount detected using a focus signal read out from an image sensor 121, and transmits a focus instruction including the focus-lens driving amount to the lens control circuit 138. Upon receiving the focus instruction, the lens control circuit 138 controls driving of the focus lens via the AF drive circuit 139. Thereby, AF is performed.

The aperture drive circuit 140 is connected to an aperture actuator such as a stepping motor (not illustrated) and drives a plurality of aperture blades (not illustrated) that form a stop aperture in the electromagnetically driven diaphragm 142. By driving the plurality of aperture blades, the size (aperture diameter) of the aperture opening is changed, thereby adjusting a light amount. The MPU 130 calculates an aperture drive amount based on a luminance signal read out from the image sensor 121, and transmits an aperture instruction including the aperture drive amount to the lens control circuit 138. That is, the MPU 130 communicates with the lens control circuit 138 to control the electromagnetically driven diaphragm 142. Upon receiving the aperture instruction, the lens control circuit 138 controls driving of the electromagnetically driven diaphragm 142 via the aperture drive circuit 140. Thereby, a proper aperture value is automatically set.

A mechanical focal-plane shutter 150 is driven by the shutter drive circuit 132. During imaging, when the shutter button 102 is pressed, a front curtain (not illustrated) travels to open the shutter, and a rear curtain (not illustrated) travels after a desired exposure time to close the shutter, thereby controlling an exposure time of the image sensor 121.

An electronic-optic filter (optical filter) 160 is an optical element that provides a special effect to an image by diffusing incident light or attenuating a specific wavelength range. The electro-optic filter 160 is included in a filter unit 161. The filter-unit drive circuit 137 may move a position of the electro-optic filter 160 by driving the filter unit 161. The electro-optic filter 160 is driven by the electro-optic filter (EOF) drive circuit 162. For example, by adjusting the density of the electro-optic filter 160, an attenuation amount of incident light may be changed.

The electro-optic filter 160 may be any optical member such as an electronic ND filter or a polarizing filter. For example, an electronic ND filter widely uses liquid crystal, and by controlling a voltage applied to the liquid crystal, a light transmittance may be changed (the incident light amount is attenuated at a set rate). The image pickup apparatus 100 can normally operate even in a state where the electro-optic filter 160 is not inserted.

An imaging unit 120 includes an optical low-pass filter 122, an optical low-pass filter holding member 123, a piezoelectric element 124, and the image sensor 121. The image sensor 121 photoelectrically converts an object image. In this embodiment, a CMOS sensor is used as the image sensor 121, but another device such as a CCD-type, CMOS-type, or CID-type device may be used. The optical low-pass filter 122 is disposed in front of the image sensor 121 and is a single birefringent plate made of quartz having a rectangular shape. The piezoelectric element 124 is a single-plate piezoelectric element that is vibrated by the piezoelectric element drive circuit 145 according to an instruction from the MPU 130, thereby transmitting vibration to the optical low-pass filter 122. Thereby, fine dust adhering to the optical low-pass filter 122 may be shaken off.

The video signal processing circuit 136 performs overall image processing such as filter processing and data compression processing on an electrical signal obtained from the image sensor 121. Image data for monitor display from the video signal processing circuit 136 is displayed on the liquid crystal monitor 111 and the electronic viewfinder 112 via a liquid crystal drive circuit 144. The video signal processing circuit 136 may also store image data in a buffer memory 147 via a memory controller 146 in accordance with an instruction from the MPU 130. The video signal processing circuit 136 may perform image data compression processing such as JPEG compression. In continuous shooting such as burst shooting, image data may be stored in the buffer memory 147 and unprocessed image data may be sequentially read via the memory controller 146. This allows the video signal processing circuit 136 to perform image processing and compression processing sequentially regardless of the speed of the input image data.

The memory controller 146 has a function of storing image data in an external recording medium 148 and a function of reading image data stored in the external recording medium 148. The external recording medium 148 can use an SD card, a CF card, or the like detachably mountable to the image pickup apparatus 100.

The switch sense circuit 133 transmits an input signal to the MPU 130 in accordance with an operation state of each switch. A switch SW1 (102a) is turned on by a first stroke (half-press) of the shutter button 102. A switch SW2 (102b) is turned on by a second stroke (full-press) of the shutter button 102. When the switch SW2 (102b) is turned on, an instruction to start imaging is transmitted to the MPU 130. The switch sense circuit 133 is connected to the main electronic dial 108, the mode switching dial 109, the power switch 107, the setting button 110, and the multi-function button 113.

The MPU 130 communicates via an accessory communication control circuit 118 and the accessory contacts 116 to utilize functions of an accessory unit (not illustrated).

The power supply circuit 134 distributes and supplies power from a battery 143 to respective elements of the image pickup apparatus 100. The battery check circuit 135 is connected to the battery 143 and transmits remaining battery capacity information to the MPU 130.

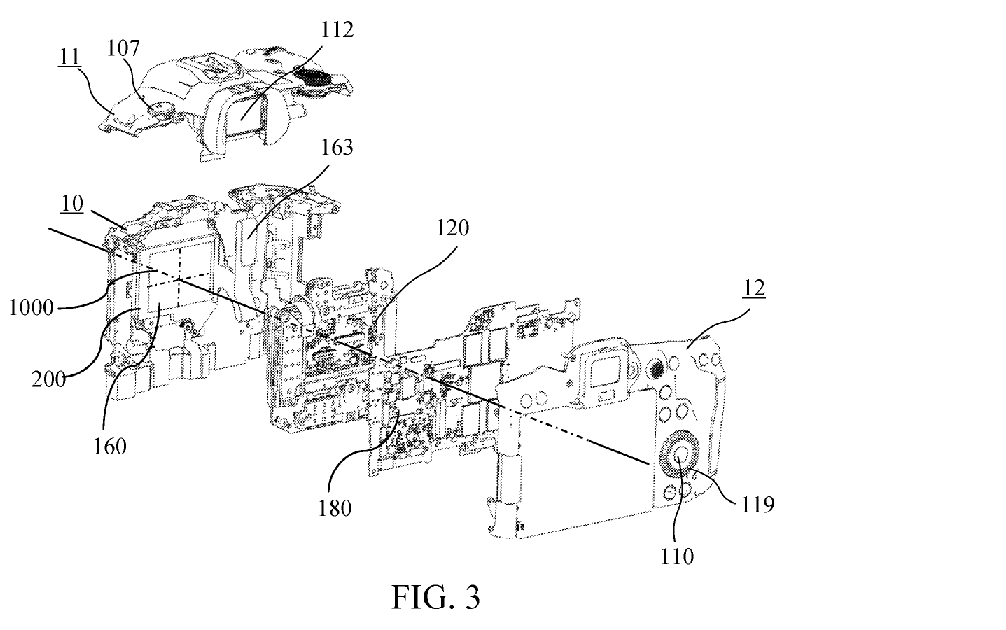

FIG. 3 is an exploded perspective view of the image pickup apparatus 100. The image pickup apparatus 100 is covered by exterior members including a front cover 10, a top cover 11, and a rear cover 12, and operation members and display members are attached to respective exterior members. On an optical axis 1000, an electro-optic-filter holding member 200, the imaging unit 120, and a main substrate 180 are arranged in this order from an object side to an image side. The electro-optic filter 160 is held by the electro-optic-filter holding member 200. An electrical connection member (connection member) 163 is connected to the electro-optic filter 160. The electrical connection member 163 is connected to the main substrate 180. Driving of the electro-optic filter 160 is controlled via the electrical connection member 163 to change its optical characteristics.

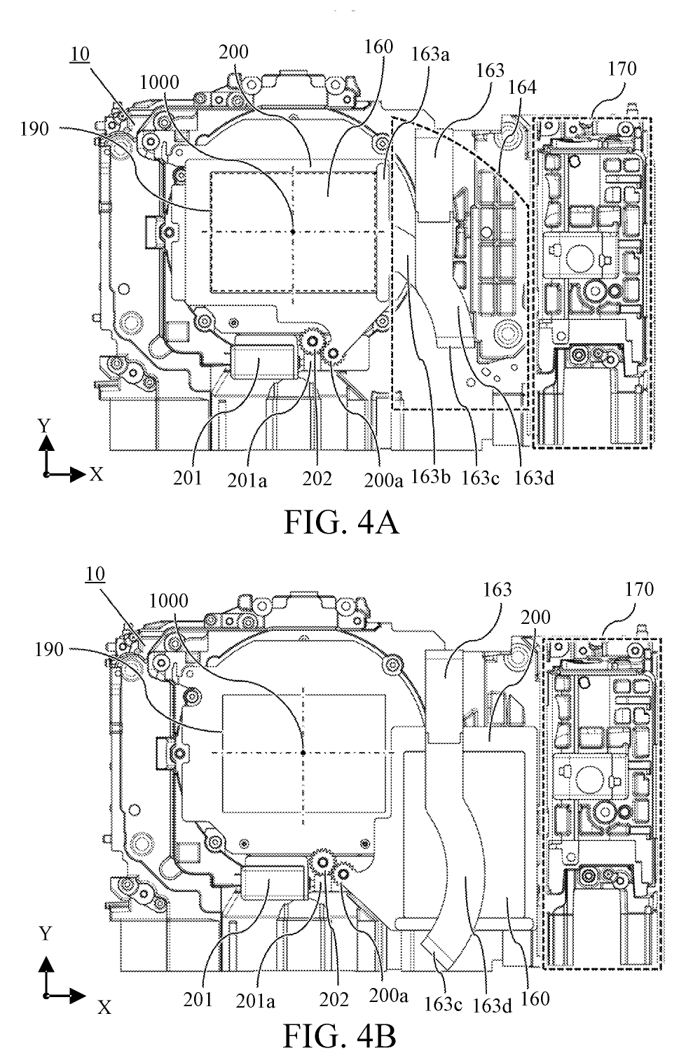

With reference to FIGS. 4A and 4B, the configuration of the electro-optic filter 160 will be described. FIGS. 4A and 4B are configuration diagrams during driving the electro-optic filter 160, and illustrate the components related to the electro-optical filter 160 and the electro-optic filter holding member 200 when viewed from the rear side of the image pickup apparatus 100.

As described above, the electro-optic filter 160 is held by the electro-optic-filter holding member 200. The electro-optic-filter holding member 200 includes a gear shape 200a and is rotatably attached to the front cover 10 about the gear shape 200a. A motor 201 for driving the electro-optic filter 160 is attached to the front cover 10. A worm gear 201a is mounted on a drive shaft of the motor 201. The worm gear 201a transmits rotational force to the gear shape 200a via an idler gear 202. Thereby, the electro-optic-filter holding member 200 can be rotated. A battery housing portion 170 for housing the battery 143 is provided on the right side of the front cover 10.

Referring now to FIGS. 4A and 4B, a description will be given of an operation performed when the electro-optic filter 160 is rotationally driven. The electro-optic filter 160 is rotatable by 90 degrees between a position illustrated in FIG. 4A (a first position) and a position illustrated in FIG. 4B (a second position). Here, the 90-degree rotation includes not only a strictly 90-degree rotation but also a substantially 90-degree rotation (approximately 90-degree rotation).

FIG. 4A illustrates a state in which the electro-optic filter 160 is inserted into and overlaps an opening 190 provided inside the lens mount portion 103 (referred to as an inserted state hereinafter). In the inserted state, light incident on the image sensor 121 passes through the electro-optic filter 160, thereby enabling various photographic expressions. For example, in a case where an electronic ND filter is used for the electro-optic filter 160, incident light is reduced, enabling long-exposure imaging and suppression of white out even in a bright environment.

FIG. 4B illustrates a state (retracted state) in which the electro-optic-filter holding member 200 rotates by 90 degrees relative to the inserted state on a plane parallel to the imaging unit 120 and retracts from the opening 190. By retracting the electro-optic-filter holding member 200, light collected by the imaging lens unit 104 enters the image sensor 121 without passing through the electro-optic filter 160.

In a case where the image pickup apparatus 100 transitions from the inserted state illustrated in FIG. 4A to the retracted state illustrated in FIG. 4B, the MPU 130 transmits a driving instruction to the motor 201, and the motor 201 starts rotating via the filter-unit drive circuit 137. The rotational force is transmitted from the worm gear 201a to the gear shape 200a via the idler gear 202, and the electro-optic-filter holding member 200 starts rotating until reaching the retracted state illustrated in FIG. 4B.

The rotation axis of the gear shape 200a is disposed closer to the bottom surface of the image pickup apparatus 100 than the opening 190 and between the optical axis 1000 and a short side of the opening 190 on the side of the grip portion 101. Thus, as illustrated in FIG. 4B, the electro-optic-filter holding member 200 can be rotated without interfering with internal components arranged on an optical path to the image sensor 121. The motor 201 is also disposed closer to the bottom surface than the opening 190. Thereby, a power transmission distance to the gear shape 200a can be reduced, and the driving efficiency can be improved.

When the electro-optic-filter holding member 200 reaches the retracted position illustrated in FIG. 4B, the filter-unit drive circuit 137 stops the motor 201 based on a detection signal from a position sensor (not illustrated). The position sensor is a position detector such as a photo-reflector, but the timing to stop the drive may be detected using another means. For example, the rotation angle of the motor 201 may be used for detection, or a mechanical switch may be used for detection.

A rotation retraction region 164 of the electro-optic filter 160 indicated by a dotted line is a driving trajectory region when the electro-optic filter 160 is rotationally driven between a position corresponding to the inserted state (a first position) and a position corresponding to the retracted state (a second position).

In a case where the electro-optic filter 160 is inserted again, the motor 201 rotates in a direction opposite to the above-described operation, and the electro-optic-filter holding member 200 moves to the position corresponding to the inserted state illustrated in FIG. 4A. When the electro-optic-filter holding member 200 reaches the position corresponding to the inserted state illustrated in FIG. 4A, the filter-unit drive circuit 137 stops the motor 201 based on the detection signal from the position sensor, similarly to the retracted state.

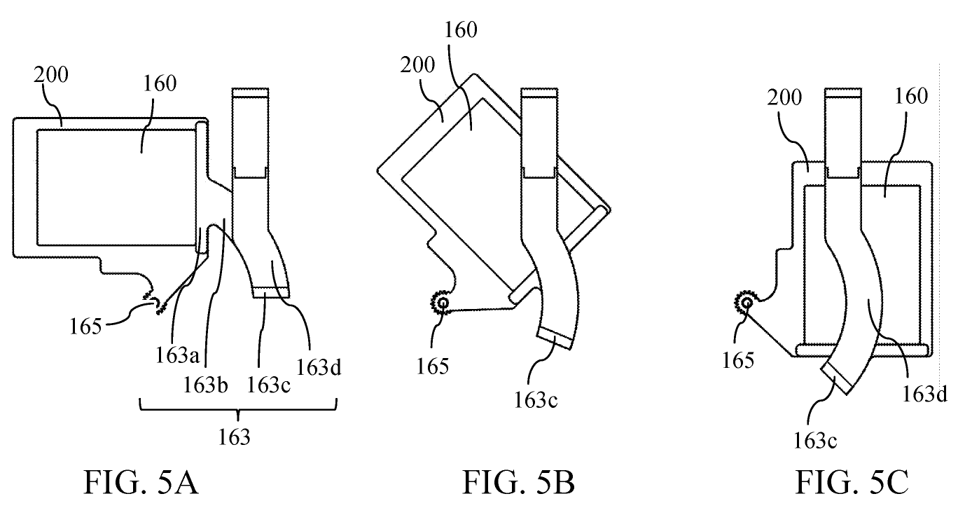

Referring now to FIGS. 5A, 5B, and 5C, a description will be given of operations of the electro-optic filter 160 and the electrical connection member 163 during rotational driving. FIGS. 5A, 5B, and 5C are explanatory views illustrating the operation of the electro-optic filter 160 and the electrical connection member 163 during rotational driving. FIG. 5A illustrates a state of the electro-optic filter 160 and the electrical connection member 163 in the inserted state. FIG. 5B illustrates a state of the electro-optic filter 160 and the electrical connection member 163 between the inserted state and the retracted state. FIG. 5C illustrates a state of the electro-optic filter 160 and the electrical connection member 163 in the retracted state.

As illustrated in FIG. 5A, the electrical connection member 163 includes an electronic filter connector (connector) 163a, a first portion 163b, a bent portion 163c, and a second portion 163d. The electronic filter connector 163a is connected to the electro-optic filter 160. The first portion 163b extends from the electronic filter connector 163a toward the rotation retraction region 164 of the electro-optic filter 160 and is connected to the bent portion 163c. The bent portion 163c is connected to the first portion 163b and also to the second portion 163d.

While the image pickup apparatus 100 transitions from the inserted state to the retracted state, and while the image pickup apparatus 100 transitions from the retracted state to the inserted state, the electrical connection member 163 follows rotational driving about a rotation center 165 of the electro-optic filter 160 as the bent portion 163c moves. Here, in the inserted state illustrated in FIG. 5A, the second portion 163d does not overlap the electro-optic filter 160 in an optical-axis direction (when viewed from an object side). On the other hand, in the retracted state illustrated in FIG. 5C, the second portion 163d overlaps the electro-optic filter 160 in the optical-axis direction (when viewed from the object side). Thus, the electrical connection member 163 can be connected to the electro-optic filter 160 without interfering with internal components disposed on the optical path to the image sensor 121. Thereby, the size of the image pickup apparatus 100 can be reduced in the optical-axis direction while the image pickup apparatus 100 includes the rotationally driven electro-optic filter 160.

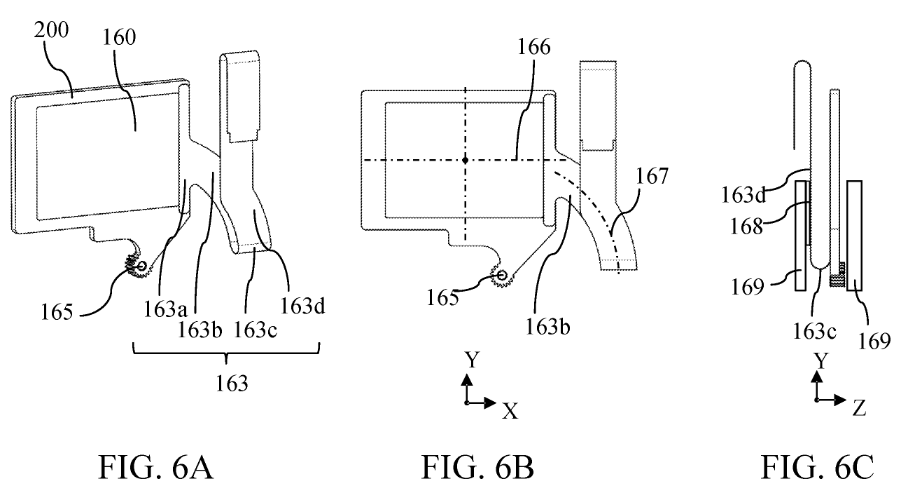

Referring now to FIGS. 6A, 6B, and 6C, a description will be given of details of the electro-optic filter 160 and the electrical connection member 163. FIGS. 6A, 6B, and 6C are detailed explanatory views of the electro-optic filter 160 and the electrical connection member.

FIG. 6A is a perspective view of the electro-optic filter 160 and the electrical connection member 163. The first portion 163b has an arc shape concentric with a rotation center (pivot center) 165 of the electro-optic filter 160. Thereby, the electrical connection member 163 may accommodate rotational driving of the electro-optic filter 160. Here, “concentric” includes not only strictly concentric but also substantially (or approximately) concentric.

FIG. 6B illustrates the electro-optic filter 160 and the electrical connection member 163 when viewed in the optical-axis direction. The first portion 163b extends such that a width center 167 of the first portion 163b is positioned at a center 166 of a short side of the electro-optic filter 160, or closer to the rotation center 165 than the center 166. Here, “center” includes not only strictly center but also substantially (or approximately) center. Since the electro-optic filter 160 is rotationally driven, by setting an extending position of the electrical connection member 163 as described above, the size of the electrical connection member 163 can be reduced.

FIG. 6C illustrates the electro-optic filter 160 and the electrical connection member 163 when viewed from an X-axis direction orthogonal to the optical axis. The bent portion 163c is fixed by being sandwiched in the optical-axis direction (from an object side and an image side) by sandwiching members 169. The sandwiching members 169 may be dedicated members, or surrounding members of the electrical connection member 163 such as the front cover 10 or the main substrate 180 may be used. At least a part of the second portion 163d is fixed to the sandwiching member (fixing portion) 169 by a fixing member 168 such as a double-sided tape. Thus, the bent portion 163c may follow rotational driving with a stable bent shape, thereby improving bending durability.

When the rotationally driven electro-optic filter 160 is mounted, the configuration of the present embodiment can reduce the size of the image pickup apparatus 100 in the optical-axis direction by utilizing a driving space.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An image pickup apparatus to which a lens apparatus is detachably attachable via a mount portion, the image pickup apparatus comprising:
an optical filter rotatable between a first position that covers an opening provided inside the mount portion and a second position that does not overlap the opening; and
a connection member that electrically connects the optical filter and a substrate,
wherein the connection member includes a connector connected to the optical filter, a first portion extending from the connector, a bent portion connected to the first portion, and a second portion connected to the bent portion,
wherein, in a case where the optical filter is located at the first position, the first portion extends toward a rotation retraction region of the optical filter, and the optical filter and the second portion do not overlap each other when viewed from an object side, and
wherein, in a case where the optical filter is located at the second position, the optical filter and the second portion overlap each other when viewed from the object side.

2. The image pickup apparatus according to claim 1, wherein the first portion has an arc shape concentric with a rotation center of the optical filter.

3. The image pickup apparatus according to claim 1, further comprising a fixing portion configured to fix at least a part of the second portion.

4. The image pickup apparatus according to claim 1, wherein the first portion extends such that a width center of the first portion is positioned at a center of a short side of the optical filter or closer to a rotation center of the optical filter than the center.

5. The image pickup apparatus according to claim 1, wherein the optical filter is rotatable by 90 degrees between the first position and the second position.

6. The image pickup apparatus according to claim 1, further comprising a sandwiching member configured to sandwich the bent portion from the object side and an image side.

7. The image pickup apparatus according to claim 1, further comprising an image sensor configured to photoelectrically convert an object image.

8. The image pickup apparatus according to claim 1, further comprising a control unit disposed on the substrate and configured to control the optical filter.
